(19) United States
(12) Patent Application Publication
(10) Pub. No.: US 2025/0050606 A1
(43) Pub. Date: Feb. 13, 2025

(54) PULL-OUT TAB EJECTOR

(71) Applicant: BRIDGESTONE BANDAG, LLC, Nashville, TN (US)

(72) Inventor: Troy A. Kost, Muscatine, IA (US)

(73) Assignee: BRIDGESTONE BANDAG, LLC, Nashville, TN (US)

(21) Appl. No.: 18/720,405

(22) PCT Filed: Dec. 6, 2022
(86) PCT No.: PCT/US2022/080962

§ 371 Date: Jun. 14, 2024

Related U.S. Application Data
(60) Provisional application No. 63/291,195, filed on Dec. 17, 2021.

(51) Int. Cl. B29D 30/52; B29D 30/06

(52) U.S. Cl. CPC B29D 30/52; B29D 30/0606; B29D 2030/0607

(57) ABSTRACT

A tire tread forming system is provided. The system includes a tire tread mold configured to receive uncured rubber, and a tab system coupled to the tire tread mold. The tab system includes a tab mold contiguous with the tire tread mold and including a tab recess therein, an actuator, and a tab ejector operably coupled to the actuator, the actuator being configured to cause the tab ejector to move so as to eject a pull-out tab from the tab recess of the tab mold.

### BACKGROUND

Retreaded tires provide an economical way to gain additional use from tire casings after the original tread or retread has become worn. In a typical retreading process, a worn tread on a used tire is removed and a new tire tread is bonded to the used tire. A method of manufacturing a tire tread involves filling a tire tread mold with rubber and curing the rubber in the tire tread mold. The precured tire tread must then be removed from the tire tread mold so that it may be used for retreading.

### SUMMARY

In one embodiment, a tire tread forming system including a tire tread mold configured to receive uncured rubber, and a tab system coupled to the tire tread mold. The tab system including a tab mold contiguous with the tire tread mold and including a tab recess therein, an actuator, and a tab ejector operably coupled to the actuator, the actuator being configured to cause the tab ejector to move so as to eject a pull-out tab from the tab recess of the tab mold.

Another embodiment relates to a method for forming a tire tread. The method includes receiving, by a tire tread mold, uncured rubber, forming, by the tire tread mold, a tire tread, the tire tread including a pull-out tab, curing the tire tread to form a cured tire tread, automatically controlling a pull-out tab ejector in communication with a tab mold to eject, by the pull-out tab ejector, the pull-out tab from the tab mold, and removing the cured tire tread via the pull-out tab.

Another embodiment relates to a system for forming and ejecting a pull-out tab. The system comprising a tab mold configured to receive uncured rubber, a controller, and a tab ejector communicatively coupled to the controller and configured to move in response to a signal from the controller. The tab ejector configured to facilitate ejection of the pull-out tab from the tab mold responsive to the signal from the controller, wherein the tab ejector is movably disposed beneath the pull-out tab when the pull-out tab is in the tab mold.

This summary is illustrative only and is not intended to be in any way limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a system for forming and ejecting a tab coupled to a tire tread mold, according to an example embodiment;

FIG. 2 is a perspective view of the system and tire tread mold of FIG. 1 with a formed tire tread;

FIG. 3 is a perspective view of the system and tire tread mold of FIG. 1 with a formed tire tread ejected;

FIG. 4 is a side view of the system and tire tread mold of FIG. 3;

FIG. 5 is a top view of the system and the tire tread mold of FIG. 3;

FIG. 6 is a front view of the system and tire tread mold of FIG. 1;

FIG. 7 is a bottom view of the system and tire tread mold of FIG. 1; and

FIG. 8 is a method for using the system for forming and ejecting a tab, according to an example embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As used herein, the term “cure” and “cured” refers to the process of hardening raw material and/or the hardened material itself.

As used herein, the term “precured” refers to a material that is cured. Conversely, “uncured” refers to materials that are in their raw form and have not been cured. For example, curing an uncured material results in a cured or precured material.

As used herein, the term “tire tread” refers to a portion of rubber with patterns formed (e.g., cut, molded, etc.) within to increase the grip strength between the tire tread and the ground.

As used herein, the term “precured tire tread” refers to a tire tread that is separate from a tire casing. The precured tire tread has been cured and may take the form of a strip, ellipse, oval, circle, ring, or the like.

In order to retread a tire, a precured tire tread must first be manufactured. The precured tire tread is formed of uncured rubber that is cured in a mold to form the precured tire tread. The mold defines the shape of the precured tire tread and any features (e.g., channels, grooves, etc.) of the precured tire tread. The precured tire tread may be a blank (e.g., slick) without any features. The precured tire tread must then be removed from the mold for use in the retreading process.

Removing the precured tire tread from the mold may involve clamping down on portions of the precured tire tread and pulling the precured tire tread out of the mold. This process may damage a portion of the precured tire tread. The damaged portion may be unsuitable for use and may need to be removed by an operator, thereby producing waste. Furthermore, finding a portion to clamp onto may be time and/or labor intensive as an operator needs to pry the tire tread out of the tire mold. The exemplary non-limiting embodiments of the present disclosure provide for a device and a method for removing a portion of a precured tire tread from a mold that reduces waste and increases efficiency in the manufacturing process by quickly removing the precured tire tread.

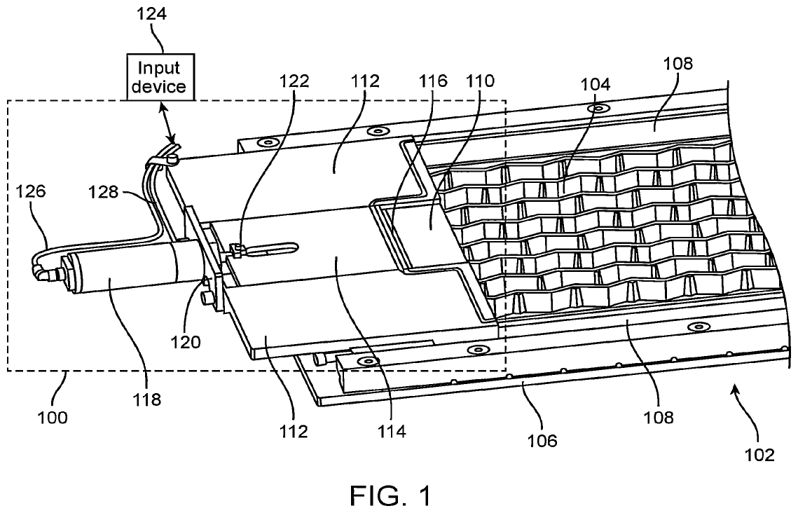

Referring now to FIG. 1, a system 100 for forming and ejecting a tab fixedly coupled to a tire tread mold 102 is shown. The tire tread mold 102 includes a tread pattern 104, a base 106, and sidewalls 108. The tire tread mold 102 is configured to receive uncured rubber to form a tire tread. The tread pattern 104 is a positive (e.g., extruded surface) that defines the features (e.g., grooves, channels, sipes, etc.) of the tire tread. The tread pattern 104 is coupled to a base 106 and is interposed between sidewalls 108, and the sidewalls 108 are fixedly coupled to the base 106. The base 106 and the sidewalls 108 constrain uncured rubber from spreading beyond an intended tire tread shape. The sidewalls 108 extend away from the base 106 past the tread pattern 104 to provide a surface for uncured rubber to contact during the molding process.

The resulting tire tread includes a rubber cushion extending past the channels formed by the tread pattern 104. In some embodiments, the tire tread mold 102 may be coated with a non-stick coating and/or a releasing agent (e.g., silicone, oil, polytetrafluoroethylene, etc.) that allows for the cured tire tread to be removed from the tire tread mold 102. The components of the tire tread mold 102 are configured to withstand temperatures and chemical processes associated with the curing (e.g., of rubber) process. While the system 100 and the tire tread mold 102 generally receive uncured rubber as part of the tire tread manufacturing process, the systems and methods described herein may be used with other materials used to manufacture tires such as synthetic rubber, steel, nylon, silica, polyester, carbon black, petroleum and the like or any combination thereof. In some embodiments, the materials used to manufacture tires may be applied to the tire tread mold 102 in layers.

The system 100 is configured to form a pull-out tab (e.g., flap, fold, etc.) on a tire tread during the tire tread manufacturing process and eject (e.g., release, isolate, separate, etc.) the tab once the tire tread is cured and formed. The system 100 allows for a precured tire tread to be prepared for removal from the tire tread mold 102 without a user completing manual steps, such as prying the tire tread from the tire tread mold 102 to allow extraction from the tire tread mold 102. The formed tab on the tire tread provides a surface by which the tire tread may be pulled from the tire tread mold 102. The tab is configured to be removed from the tire tread after the tire tread has been removed from the tire tread mold 102. The tab is sized such that there is reduced material loss resulting from removing the tire tread from the tire tread mold 102.

In some embodiments, the system 100 is integrally formed as part of the tire tread mold 102. The system 100, as well as the tire tread mold 102, may be part of an automatic tire tread forming system. In some embodiments, the system 100 is operably coupled to a controller. The controller includes at least a processer and a memory, configured to control the functionality of system 100 and/or monitoring the status (e.g., component temperature, ambient temperature, total uses, etc.) the system 100 via at least one sensor in the system 100. The system 100 includes a tab recess 110 defined by a tab mold 112, an ejector 114 including an ejector leading edge 116, and an actuator 118 coupled to the tab mold 112 via an actuator bracket 120 and coupled to the ejector 114 via an actuator coupler 122. The actuator 118 is further coupled to an input device 124 via a first actuator conduit 126 and a second actuator conduit 128.

The tab mold 112 is configured to fixedly couple the system 100 to the tire tread mold 102. In some embodiments, the tab mold 112 is formed of steel, aluminum, tungsten, or any other material capable of withstanding the conditions (e.g., temperature, chemical exposure, etc.) of tire tread manufacture. When affixed to the tire tread mold 102, the tab mold 112 is coupled to the tire tread mold 102 such that the tab mold 112 is substantially coplanar with the sidewalls 108. In some embodiments, the tab mold 112 may be an end cap for the tire tread mold 102, thereby defining an end of a molded tire tread.

The tab mold 112 defines a tab recess 110, which is a depressed portion of the tab mold 112. When the tire tread mold 102 receives uncured rubber, a portion of that uncured rubber flows into the tab recess 110, forming a tab that may be used to pull the precured tire tread out of the tire tread mold 102. The depth of the tab recess 110 is configured such that the tab formed by the tab recess 110 includes enough material thickness such that the tab will not shear from the precured tire tread when the tab is used to pull the precured tire tread from the tire tread mold 102. In some embodiments, the tab recess 110 may be rectangular. In some embodiments, the tab recess 110 may be any shape that allows for a clamp to latch onto the tab recess 110 (e.g., square, triangle, semicircular, etc.). The tab recess 110 may include a coating (e.g., silicon, oil, etc.) that provides a non-stick surface. In some embodiments, the tab recess 110 is configured to receive a non-stick agent prior to each use.

The tab mold 112 further includes a channel through which an ejector 114 operably slides into the tab recess 110 to eject a formed pull-out tab. The tab mold 112 includes rails along the sides of the channel along which the ejector 114 slides. The rails may be of any shape (e.g., dovetail, rectangular, etc.) such that the ejector 114 remains substantially coplanar with the tab mold during operation. The ejector 114 is an inclined plane that tapers down to an ejector leading edge 116. The ejector leading edge 116 may be sharpened to a point. In some embodiments, the taper is about 0.25 inches, or between about 0.2 inches to about 0.4 inches. In some embodiments, the ejector is formed of oil impregnated bronze or other material capable of maintaining an edge over repeated use. When the ejector 114 is operated to eject a tab formed in the tab recess 110, the ejector leading edge 116 engages the tab and pushes the tab up and over the ejector 114. In some embodiments, the ejector 114 may include additional extrusions (e.g., wedges, ramps, etc.) that are configured to position the tab to facilitate grabbing on to the tab (e.g., by a device or user who removes the tire tread from the tire tread mold 102).

The ejector 114 is operated by an actuator 118. The actuator 118 is coupled to the tab mold 112 via an actuator bracket 120. The actuator bracket 120 mounts the actuator 118 fixedly to the tab mold 112 such that the actuator does not move (e.g., translate, rotate, etc.) and remains stationary relative to the tab mold 112 during operation. The actuator bracket may be formed of steel or any other material capable of withstanding forces associated with ejecting the tab. The actuator is operably coupled to the ejector 114 via an actuator coupler 122. The actuator coupler 122 may be an arm extending from the actuator 118 that is fixedly coupled to the ejector 114 so that when the actuator 118 translates the actuator coupler 122, the ejector 114 slides along the channel of the tab mold 112 in tandem. In some embodiments, the actuator coupler 122 may include any number of linkages to operably couple to the ejector 114.

The actuator 118 is configured to operate the ejector 114 via the actuator coupler 122. The actuator 118 may be a piston within a cylinder housing that translates the actuator coupler 122. The piston may be operated pneumatically (e.g., using air or gas), electrically, or hydraulically (e.g., using water or a liquid). The actuator 118 operates responsive to receiving a control signal (e.g., electric current, hydraulic pressure, pneumatic pressure, etc.). For example, when the actuator 118 is a pneumatic system, a gas conduit may pump air into the actuator 118. The added air slides a piston that in turn actuates the actuator coupler 122. In some embodiments, the actuator 118 may be a servo-mechanism that operates the actuator coupler 122. In some embodiments, the actuator 118 includes a damper configured to limit the actuation speed of the actuator 118. In some embodiments, the actuator 118 may include an on-board computer (e.g., processor, memory, etc.) that alters one or more operational parameter (e.g., actuation speed, actuation depth, etc.) of the system 100. In some embodiments, the actuator 118 may be reconfigured to be replaced with another actuator 118 depending on the use-case of the system 100. For example, if the tire tread is made of a tougher material than in a previous use-case, the actuator 118 in the system 100 may be replaced with another actuator 118 that may be configured to withstand higher loads associated with operating the ejector 114.

Referring further to FIG. 1, the system 100 is coupled to an input device 124 via a first actuator conduit 126 and a second actuator conduit 128. The first actuator conduit 126 and second actuator conduit 128 are communicably coupled to the input device 124 and the actuator 118. The first actuator conduit 126 and the second actuator conduit 128 are configured to send and receive signals to/from the actuator 118. The conduits (e.g., 126 and 128) may vary depending on configuration of the system 100. For example, the conduits may be electronic connectors (e.g., cables, wires, etc.), fluid conduits (e.g., tubing, piping, etc.), high pressure conduits (e.g., gas lines, etc.), or the like. In some embodiments, the conduits may be flexible and repositionable such that the conduits can be repositioned as to not interfere with the function of the system 100. The conduits may be fixedly coupled to other components of the system 100 as to constrain them.

The input device 124 may include a controller (e.g., a microcomputer, programmable logic controller (PLC), a proportional integral derivative (PID) controller, etc.), to actuate the actuator 118. The controller may be implemented as a microprocessor provided with a non-transitory computer readable memory which is configured to store instructions that, when executed by the processor, cause the controller to carry out particular control operations to control the actuator 118.

In some embodiments, the input device 124 may include a pneumatic device or system such as a compressor. The input device 124 may be provided with components (such as at least one valve and at least one fluid reservoir) to facilitate control of the compressor and/or coupling of the compressor to one or more other system components. For example, when the actuator 118 is a pneumatic system, the input device 124 may include a controller, pump, compressor, and reservoir. In this embodiment, the controller instructs the pump to send compressed gas from the reservoir to the actuator 118 via the first actuator conduit 126. The compressed gas pushes a cylinder in the actuator 118, thus actuating the ejector 114. Once the tab has been ejected, the controller may instruct the pump to send compressed gas from the reservoir to the actuator 118 via the second actuator conduit 128. The compressed gas pushes the cylinder in the actuator 118 back to the original position, thus pulling back the ejector 114. By way of another example, such as when the actuator 118 is an electrically operated device such as a motor or a servomechanism (e.g. a servomotor), the input device 124 may include a controller configured to send electric signals to the actuator 118 via a conduit. The signals correspond to the actuator 118 being in an activated (actuated) state or a deactivated (de-actuated) state.

Referring to the input device 124, the input device 124 may send an activation (e.g., signal for the actuator 118 to push the ejector 114 out) then send a deactivation signal (e.g., a signal for the actuator 118 to pull the ejector 114 back) after a predetermined period of time (e.g., 1 second, 2 seconds, 5 seconds, 10 seconds, 30 seconds, 1 minute, 5 minutes, etc.). In some embodiments, the activation signal and the deactivation signal may be implemented by commands input to the controller by a user. In some embodiments, the activation signal and the deactivation signal may be sent in response to a change in status (e.g., the precured tire tread has been removed from the tire tread mold 102. In some embodiments, the input device 124 and the actuator 118 may include wireless communication devices (e.g., Wi-Fi, Bluetooth, etc.) that allow for the input device 124 and the actuator 118 to intercommunicate. For example, the input device 124 may send an activation signal wirelessly to the actuator 118. The actuator 118 receives the activation signal from the input device 124 and operates according to the activation signal.

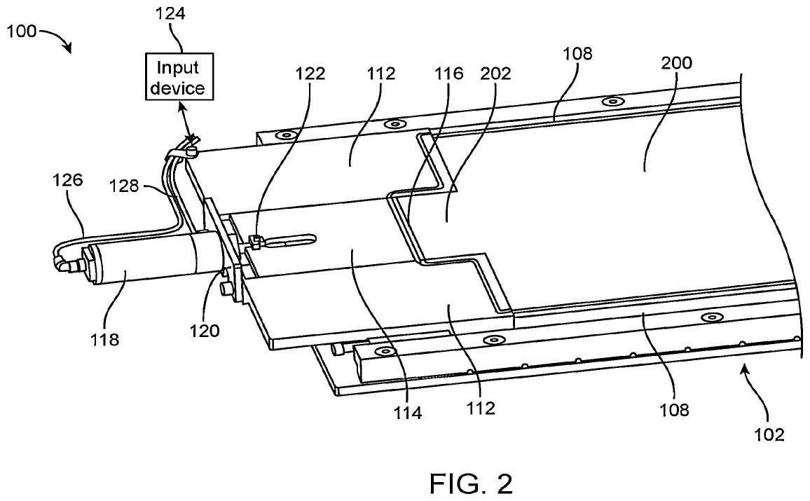

Referring now to FIG. 2, the system 100 and the tire tread mold 102 of FIG. 1 are shown, with the inclusion of a tire tread 200 and a tread tab 202. The embodiment of FIG. 2 depicts the system 100 and the tire tread mold 102 after receiving uncured rubber. As depicted in FIG. 2, the tread tab 202 forms in the tab recess 110 as defined by the tab mold 112. The tread tab 202 is defined by the tab mold 112 and the ejector leading edge 116. The tread tab 202 is contiguous with the tire tread 200 which forms in the tire tread mold 102.

The actuator 118 and the ejector 114, as seen in FIG. 2 are in a pulled-back, or deactivated, position. The ejector 114 is configured to be disposed (at least in part) beneath the tread tab 202 when the tread tab 202 is in the tab mold 112. In this position, the ejector 114 is disposed such that the tread tab 202 lies substantially coplanar with the tire tread 200. In some embodiments, the ejector leading edge 116 may be under the edge of the tread tab 202, allowing for the ejector 114 to eject the tread tab 202. The ejection may occur while the ejector 114 is moving (e.g., in a lateral direction). The system 100 may be in the configuration of FIG. 2 while the tire tread mold 102 receives uncured rubber, or while the uncured rubber is being cured to form a tire tread 200.

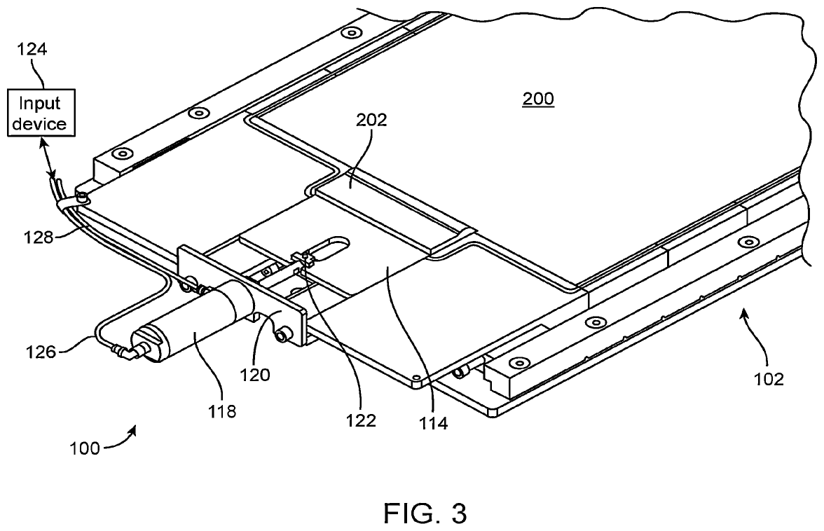

Referring now to FIG. 3, the system 100 and the tire tread mold 102 of FIG. 1 are shown, with the inclusion of the tire tread 200 and the tread tab 202. In the configuration of FIG. 3, the tread tab 202 is ejected (e.g., separated from the tab recess 110) by the ejector 114. To eject the tread tab 202, the input device 124 first sends a signal to the actuator 118. For example, the input device 124 may send compressed gas through the first actuator conduit 126 to the actuator 118, thus pushing a piston within the actuator 118. The actuator 118 then pushes the ejector 114, via the actuator coupler 122, under the tread tab 202. The inclined plane shape of the ejector 114 pushes the tab up and over the ejector 114, allowing for the tread tab 202 to be used to remove the tire tread 200 from the tire tread mold 102. In this manner, the ejector 114 dislodges the tread tab 202.

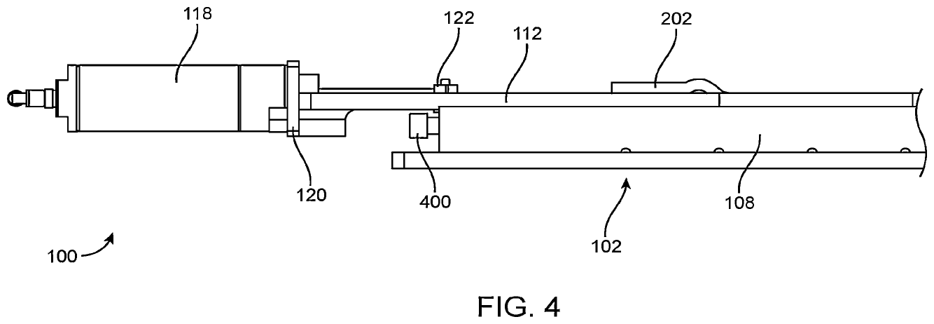

Referring now to FIG. 4, a side view of the system 100 and the tire tread mold of FIG. 3 are shown. As depicted, the actuator 118 is actuated such that the tread tab 202 is positioned by the ejector 114 (not shown) above the sidewalls 108 and the tab mold 112. In some embodiments, the ejector 114 includes additional extrusions (e.g., wedges, ramps, etc.) that may position the tread tab 202 in a different position, allowing for the tread tab 202 to be grasped by a device configured to remove the tire tread 200 from the tire tread mold 102.

FIG. 4 further depicts the actuator 118 fixedly coupled to the tab mold 112 via the actuator bracket 120. In some embodiments, such as the one depicted, the actuator bracket 120 is fixedly coupled to the tab mold 112 via fastener (e.g., screw, bolt, etc.). The actuator bracket 120 may be integrally formed (e.g., cast, welded, etc.) with the tab mold 112. In some embodiments, the actuator 118 is coupled to the actuator bracket 120 via a fastener (e.g., screw, bolt, pin, clamp, etc.). In some embodiments, the actuator bracket 120 may be slotted such that the actuator 118 may be removably coupled to the actuator bracket 120. This may allow for the actuator 118 to be swapped if a different actuator 118 is needed, depending on actuator 118 strength, speed, etc. FIG. 4 further depicts the tab mold 112 fixedly coupled to the tire tread mold 102 via at least one mounting fastener 400. The mounting fasteners 400 may be a type of fastener configured to fixedly couple the tab mold 112 to the tire tread mold 102. In some embodiments, the tab mold 112 is integrally formed with the tire tread mold 102.

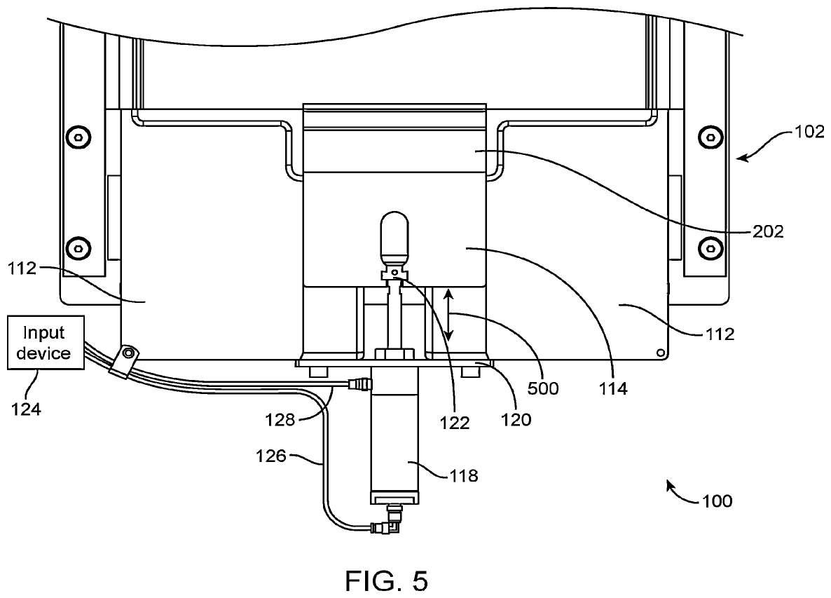

Referring now to FIG. 5, a top view of the system 100 and the tire tread mold 102 of FIG. 3 are shown. The actuator 118 is actuated such that the ejector 114 translates a travel length 500 away from the actuator bracket 120. In some embodiments, the travel length 500 is preset such that the actuator 118 repeatedly actuates the same distance upon receiving an activation signal. In some embodiments, the input device 124 may adjust the travel length 500 based on a variety of factors (e.g., tread material, tab recess 110 size, etc.). A different travel length 500 may be augmented by the input device 124 sending a corresponding activation signal to the actuator 118. For example, when the actuator 118 is a pneumatic system, the input device 124 may alter the travel length 500 by causing the compressor to deliver different amounts or pressures of compressed air to the actuator 118 via the first actuator conduit 126. For example, the controller may determine a target amount of pressure to be delivered and cause the compressor to deliver pressurized air at the target pressure. In another example, the input device 124 may send an electronic signal to the actuator 118, when the actuator 118 is a motor, such that the electronic signal commands the actuator 118 to move the ejector 114 along the travel length 500.

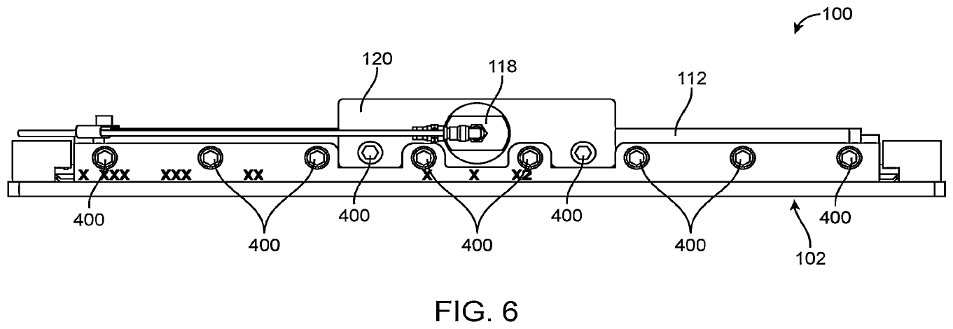

Referring now to FIG. 6, a front view of the system 100 and the tire tread mold 102 of FIG. 1 are shown. A plurality of mounting fasteners 400 are depicted. The mounting fasteners 400 fixedly couple the system 100 to the tire tread mold 102. The mounting fasteners 400 may be disposed evenly along the tab mold 112 to fixedly couple the system 100 to the tire tread mold 102. Furthermore, mounting fasteners 400 may be used to fixedly couple the actuator bracket 120 to the tab mold 112. In some embodiments, the mounting fasteners 400 may be replaced with adhesive or other joining methods (e.g., welding, etc.).

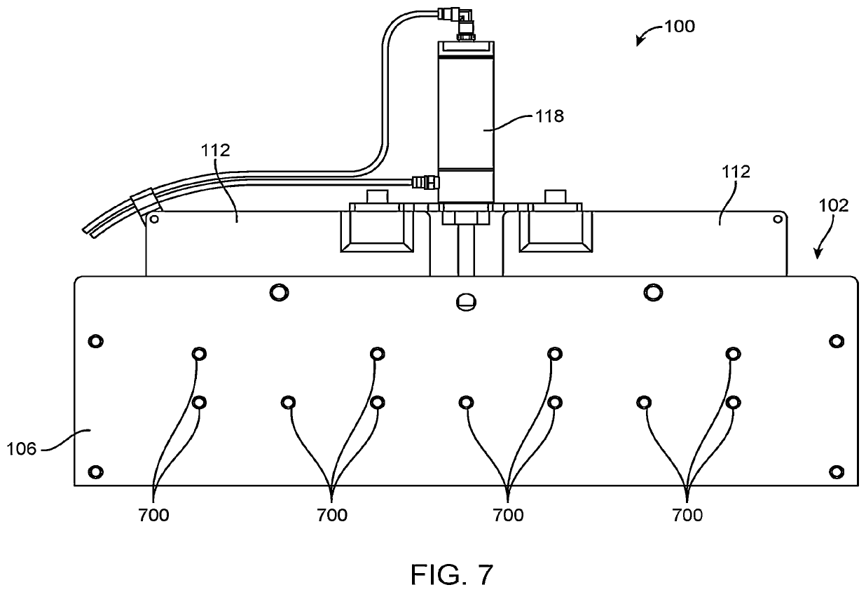

Referring now to FIG. 7, a bottom view of the system 100 and the tire tread mold 102 of FIG. 1 are shown. The tab mold 112 is fixedly coupled to the base 106 via a plurality of lower mounting fasteners 700. The plurality of lower mounting fasteners 700 couple to the base 106 via a plurality of apertures located within the base 106. In some embodiments, the lower mounting fasteners 700 may be pins in a plurality of apertures located in the base 106, configured to resist shear forces. In some embodiments, the lower mounting fasteners 700 may be replaced with adhesive or other joining methods.

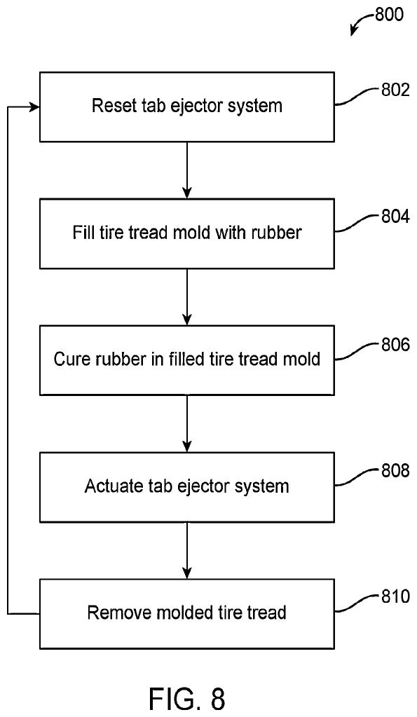

Referring now to FIG. 8, a method 800 for using the system 100 for forming and ejecting a tread tab 202, according to an example embodiment, is shown. The method 800 may be performed to repeatably produce precured tire treads. In some embodiments, the method 800 may be automated by a computing system coupled to the system 100 and other components (e.g., uncured rubber extruder, tire tread clamp, etc.) configured to complete the steps of method 800. The computing system may employ artificial intelligence algorithms to modify the method 800 as need (e.g., according to specific tire tread needs). In some embodiments, the method 800 may be manually completed by an operator. In some embodiments, an operator may utilize a computing system to complete various steps of the method 800. The computing system may comprise a computer including a processor and a memory configured to store instructions which, when executed by the processor, cause the computer to carry out particular operations as described herein.

At block 802, the input device 124 resets the system 100. Resetting the system 100 includes retracting the actuator 118 such that the ejector 114 is pulled back away from the tab recess 110, leaving the tab recess 110 open to receive uncured rubber. In some embodiments, block 802 may include applying (e.g., spraying, wiping, etc.) a non-stick agent to the tab recess 110. When the actuator 118 is a pneumatic system, resetting the system 100 includes the input device 124 sending compressed gas to the actuator 118 via the second actuator conduit 128. In embodiments where the actuator 118 is an electronic system, the input device 124 sends electronics signals to the actuator 118. In embodiments where the actuator 118 is a hydraulic system, the input device 124 sends fluid to the actuator 118 via the second actuator conduit 128.

At block 804, the tire tread mold 102 is filled with uncured rubber. The uncured rubber is added to the tire tread mold 102 to a predetermined level. The predetermined level is determined such that the uncured rubber fills the tab recess 110, thus forming the tread tab 202. The tire tread mold 102 may be filled manually or via an extruding robot configured to fill the tire tread mold. In some embodiments, fibers, chords, or chords of a secondary material (e.g., steel, aluminum, etc.) may be added to the uncured rubber to strengthen the tire tread. In some embodiments, strengthening secondary material is only added to the portion between the tire tread 200 and the tread tab 202. Providing secondary material in this area can reduce the risk of the tread tab 202 disconnecting from the tire tread 200 when the tire tread 200 is removed from the tire tread mold 102 via the tread tab 202.

At block 806, the uncured rubber in the tire tread mold 102 is cured. The curing process may include heat and/or chemical treating. The components of the system 100 are all configured to withstand the curing process so that they may remain attached during the curing process. In some embodiments, the system 100 is removed from the tire tread mold 102 prior to the curing process, then coupled back to the tire tread mold 102 after the curing process is completed. In these embodiments, the fasteners of the system 100 are configured to selectively couple the system 100 to the tire tread mold 102. In some embodiments, the system 100 may include a quick-couple configuration that allows a user to quickly couple the system 100 to the tire tread mold 102.

At block 808, once the tire tread 200 is cured, the input device 124 actuates the actuator 118. The actuator 118 actuates the ejector 114 to eject the tread tab 202 from the tab recess 110. The ejector 114 wedges under the tread tab 202 and pushes the tread tab 202 away from the tab recess 110 such that the tread tab 202 may be used to remove the tire tread 200 from the tire tread mold 102.

At block 810, the tread tab 202 is utilized to remove the tire tread 200 from the tire tread mold 102. A clamp or similar mechanism attaches the tread tab 202 to pull the tire tread 200 from the tire tread mold. The tread tab 202 provides a surface for a clamp or similar mechanism to attach to when removing the tire tread 200. The clamp may damage the portion of the tire tread 200 that the clamp attaches to. Thus, providing the tread tab 202 is beneficial, as the tread tab 202 is not an integral portion of the tire tread that will later be used during the tire retreading process. Once the tire tread 200 is removed from the tire tread mold 102, the tread tab 202 may be removed (e.g., cut off, melted off, etc.) to form a completed tire tread. The completed tire tread may then be used to use for the tire retread process. After block 810, the method 800 returns to block 802 allowing for a new tire tread to be manufactured.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled direction to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, and control functionality described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include on or more devices (e.g., RAM, ROM, Flash memory, hard disk storage) for storing data and/or computer code for completing or facilitating the various processes, layer and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structure and which can be accessed by a general purpose or special purpose computer or other machine with a processor. Combinations of the above are also included in the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of systems, arrangements, and methods as shown in the various exemplary embodiments is illustrative only. Additionally, any element disclosed in one embodiment may be incorporated or utilized with any other embodiment disclosed herein. For example, the arrangement of the exemplary embodiment described in reference to FIG. 1 may be incorporated in the method of the exemplary embodiment described in reference to FIG. 8. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A tire tread forming system, the system comprising:
a tire tread mold configured to receive uncured rubber; and
a tab system coupled to the tire tread mold, the tab system comprising:
a tab mold contiguous with the tire tread mold and including a tab recess therein;
an actuator; and
a tab ejector operably coupled to the actuator, the actuator being configured to cause the tab ejector to move so as to eject a pull-out tab from the tab recess of the tab mold.

2. The system of claim 1, further comprising:
a controller communicably coupled to the actuator, the controller configured to send at least one activation signal to the actuator to thereby automate the ejection of the pull-out tab by the tab ejector.

3. The system of claim 1, wherein the tab ejector is configured to be disposed beneath the pull-out tab when the pull-out tab is in the tab mold.

4. The system of claim 1, wherein the actuator is a pneumatic device and the system further comprises at least one actuator conduit, the at least one actuator conduit fluidly coupled to the actuator.

5. The system of claim 1, wherein the tab ejector tapers to a tab ejector leading edge.

6. The system of claim 1, wherein the tab recess configured to receive uncured rubber.

7. The system of claim 6, wherein the tab recess is coated with a non-stick coating.

8. The system of claim 7, wherein the non-stick coating is silicone.

9. A method for forming a tire tread, the method comprising:
receiving, by a tire tread mold, uncured rubber;
forming, by the tire tread mold, a tire tread, the tire tread including a pull-out tab;
curing the tire tread to form a cured tire tread;
automatically controlling a pull-out tab ejector in communication with a tab mold to eject, by the pull-out tab ejector, the pull-out tab from the tab mold; and
removing the cured tire tread via the pull-out tab.

10. The method of claim 9, further comprising removing the pull-out tab from a tab recess of the tab mold.

11. The method of claim 10, wherein the automatically controlling is performed by a programmable logic controller.

12. The method of claim 9 further comprising:
receiving, by an actuator, an activation signal from an input device,
wherein the pull-out tab ejector is operably coupled to the actuator.

13. The method of claim 12, wherein the actuator is a pneumatic actuator.

14. The method of claim 13, wherein the input device is fluidly communicably coupled to the actuator by at least one conduit.

15. The method of claim 9 further comprising:
applying, onto the tire tread mold, a non-stick coating.

16. A system for forming and ejecting a pull-out tab, the system comprising:
a tab mold configured to receive uncured rubber;
a controller; and
a tab ejector communicatively coupled to the controller and configured to move in response to a signal from the controller,
the tab ejector being configured to facilitate ejection of the pull-out tab from the tab mold responsive to the signal from the controller, wherein the tab ejector is movably disposed beneath the pull-out tab when the pull-out tab is in the tab mold.

17. The system of claim 16, wherein the tab mold further includes a tab recess.

18. The system of claim 17, wherein the tab recess is coated with a non-stick coating.

19. The system of claim 18, wherein the non-stick coating is silicone.
